(19) United States
(12) Patent Application Publication
(10) Pub. No.: US 2025/0222626 A1
(43) Pub. Date: Jul. 10, 2025

(54) ADJUSTABLE TILE NIPPER

(71) Applicant: Ishii Tools MFG. Co., Ltd., Miki-shi (JP)

(72) Inventor: Toshikazu ISHII, Miki-shi, Hyogo (JP)

(73) Assignee: Ishii Tools MFG. Co., Ltd., Miki-shi (JP)

(21) Appl. No.: 18/409,386

(22) Filed: Jan. 10, 2024

(51) Int. Cl. B28D 1/22; B26B 17/00

(52) U.S. Cl. CPC B28D 1/228; B26B 17/006

(57) ABSTRACT

A tile nipper is provided that includes a first member rotatably coupled to a second member. The first cutting edge includes a first cutting edge and the second member includes a second cutting edge. The tile nipper further include an adjustment mechanism configured to adjust a distance between the first cutting edge and the second cutting edge. The adjustment mechanism includes a first component and a second component coupled to the first component. The second component is biased away from the first or second member, and adjusting the first component while forcing the second component towards the first or second member adjusts the distance between the first and second cutting edges.

### CROSS-REFERENCE TO RELATED APPLICATIONS

This application is related to Japanese Utility Model Application No. 2023-000237, filed Jan. 11, 2023, now JP Registration No. 3241854 registered Apr. 27, 2023, the entire contents of each of which are hereby incorporated by reference.

### TECHNICAL FIELD

The present application relates generally to apparatuses, systems, and methods associated with a tool for processing tiles, and more particularly, but not by way of limitation, to an adjustable tile nipper.

### BACKGROUND

A tile nipper is a hand tool designed for cutting and shaping tiles, such as ceramic tiles. Tile nippers are particularly useful for making small, precise cuts or for trimming the edges of tiles to fit into tight or irregular spaces. Tile nippers typically have a pair of sharp, hardened jaws, that may be made of cast metal (e.g., iron), that may include carbide cutting edges welded to the jaws.

### SUMMARY

The present disclosure is generally related to a tile nipper having an adjustment mechanism configured to enable adjustment of a distance between cutting edges (e.g., blades) of the tile nipper. For instance, the adjustment mechanism may be configured to adjust the tile nipper between multiple configurations, such as first configuration in which a first maximum distance between cutting edges (opposed cutting edges) or jaws (to which the cutting edges may be attached) in an open state, and a second maximum distance between the cutting edges (opposed the cutting edges) or the jaws in the open state. The first maximum distance is different from the second maximum distance. Accordingly, the adjustment mechanism enables the tile nippers to be configured (the maximum distance between the cutting edges to be adjusted) to accommodate different sized tiles.

To illustrate, the adjustment mechanism may be operation to adjust the distance without input (e.g., operation or force) applied to the handles of the tile nipper that causes at least one of the handles to move relative to the other. Stated differently, while moving one or both handles of the tile nipper relative to one another (e.g., forced together or forced apart) does alter a distance between the cutting edges, the adjustment mechanism can adjust the distance without the handles being forced together or apart. The ability to adjust the distance between the cutting edges improves the adaptability of the tile nipper for users with different hand sizes and for tiles of different thicknesses.

In some aspects, the blades of the tile nipper may be detachable, which enables the cutting edges to be replaced, unlike typical tile nippers that have cutting edges welded to the main body. In some aspects, the material of which at least a portion of the body of the tile nipper is constructed includes aluminum, which reduces the weight of the tile nipper compared to typical tile nippers that have a body constructed of cast metal (e.g., iron), which improves the ease of use of the present tile nipper without sacrificing material strength. For instance, a user may fatigue less quickly when using the tile nipper because of the lighter weight.

In an example, a tile nipper includes a first member comprising a first cutting edge; a second member comprising a second cutting edge, the second member rotatably coupled to the first member; and an adjustment mechanism configured to adjust a distance between the first cutting edge and the second cutting edge. The adjustment mechanism includes a first component and second component coupled to the first component. The second component is biased away from the first or second member, and adjusting the first component while forcing the second component towards the first or second member adjusts the distance between the first and second cutting edges.

In an example, a tile nipper includes a first member comprising a first cutting edge and a second member comprising a second cutting edge, the second member rotatably coupled to the first member. The first member comprises a third member rotatably coupled to a fourth member at a first joint, the fourth member including the first cutting edge. The second member comprises a fifth member rotatably coupled to a sixth member at a second joint, the sixth member including the second cutting edge. The third member is rotatably coupled to the fifth member at a third joint. And the fourth member is rotatably coupled to the sixth member at a fourth joint.

Additional features and advantages of the disclosure are described in, and will be apparent from, the following Detailed Description and the Figures. The features and advantages described herein are not all-inclusive and, in particular, many additional features and advantages will be apparent to one of ordinary skill in the art in view of the figures and description. Moreover, it should be noted that the language used in the specification has been principally selected for readability and instructional purposes, and not to limit the scope of the inventive subject matter.

### BRIEF DESCRIPTION OF THE DRAWINGS

The following drawings illustrate by way of example and not limitation. For the sake of brevity and clarity, every feature of a given structure is not always labeled in every figure in which that structure appears. Identical reference numbers do not necessarily indicate an identical structure. Rather, the same reference number may be used to indicate a similar feature or a feature with similar functionality, as may non-identical reference numbers. The figures are drawn to scale (unless otherwise noted), meaning the sizes of the depicted elements are accurate relative to each other for at least the configuration depicted in the figures. If just the first reference label is used in the specification, the description is applicable to any one of the similar components having the same first reference label irrespective of the second reference label.

FIG. 1 is a block diagram of an example of a tile nipper according to one or more aspects.

FIG. 2A is a front view of another example of a tile nipper according to one or more aspects.

FIG. 2B is a rear view of the example of the tile nipper of FIG. 2A according to one or more aspects.

FIG. 3 is an exploded view of the example of the tile nipper of FIGS. 2A and 2B according to one or more aspects.

FIGS. 4A to 4D are diagrams of partial right side views of the tile nipper depicting operational stages of an adjustment mechanism of the tile nipper according to one or more aspects.

FIG. 5A is a front view of a portion of the tile nipper depicted in a first state according to one or more aspects.

FIG. 5B is a front view of the portion of the tile nipper depicted in a second state according to one or more aspects.

FIG. 6 is a perspective view of an example of components of an adjustment mechanism of the tile nipper according to one or more aspects.

FIG. 7 is a flow chart of a method of adjusting a tile nipper according to one or more aspects.

FIGS. 8A-8G are diagrams of an example tile nipper according to one or more aspects.

FIGS. 9A-9G are diagrams of an example tile nipper according to one or more aspects.

### DETAILED DESCRIPTION

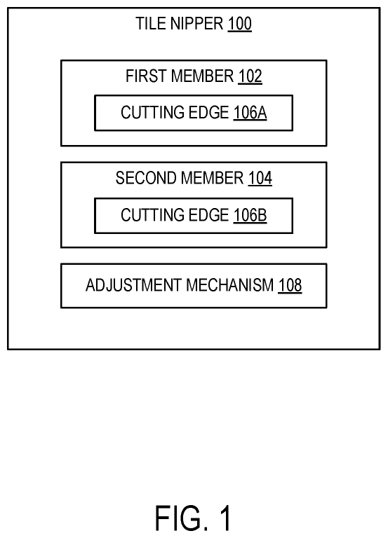

FIG. 1 is a block diagram of an example tile nipper 100. A main body of tile nipper 100 includes a member 102 (e.g., first member) coupled to a member 104 (e.g., second member). In various aspects, at least a portion of members 102, 104 may be constructed of a material that includes aluminum. For example, the at least a portion of members 102, 104 may be constructed of a material that includes aluminum, such as a combination of an aluminum alloy and iron.

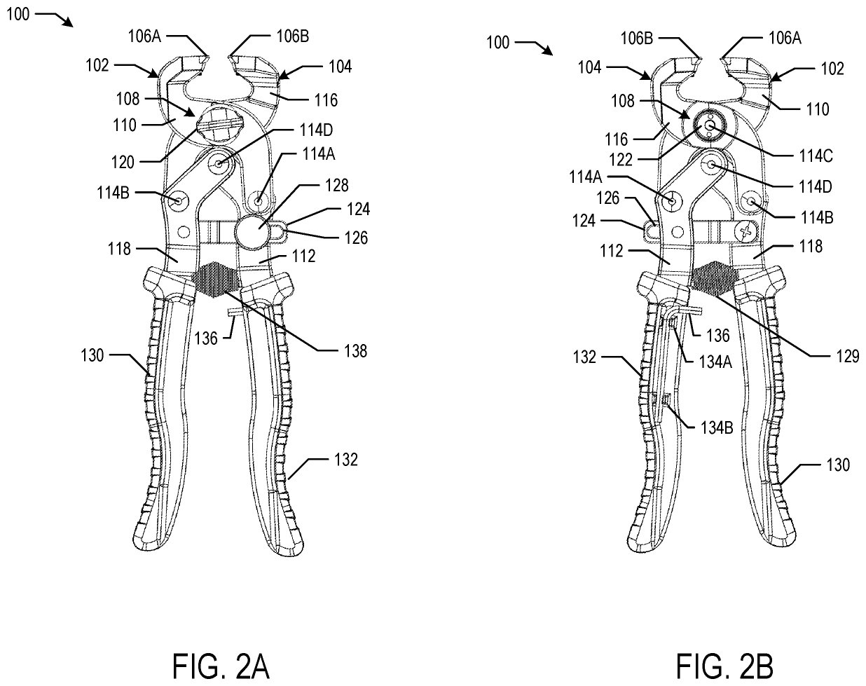

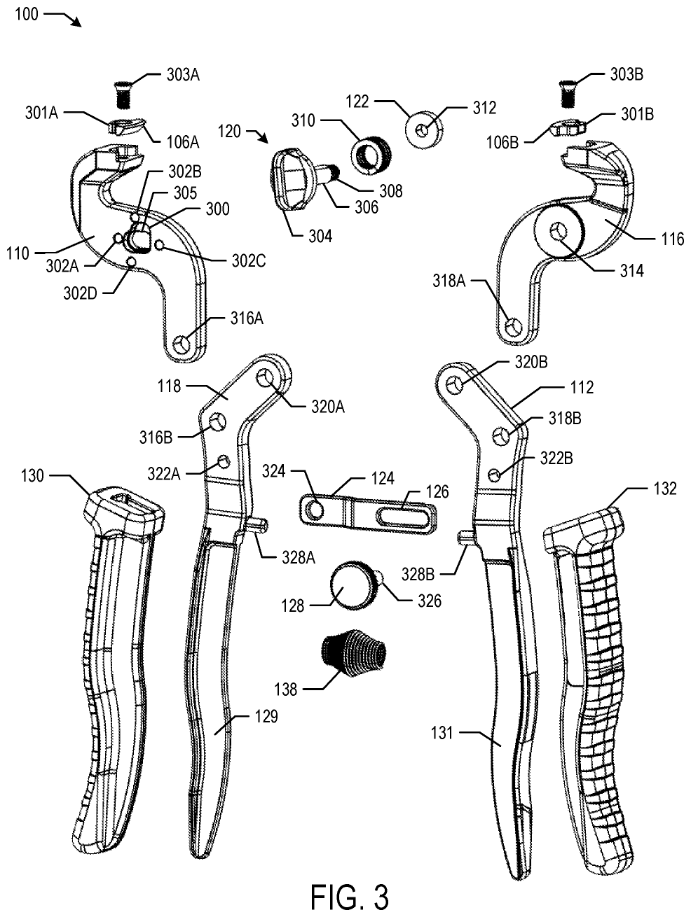

Member 102 includes a cutting edge 106A. In at least some aspects, cutting edge 106A may be removably coupled to member 102, such as with a screw. Member 104 includes a cutting edge 106B. In at least some aspects, cutting edge 106 may be removably coupled to member 104, such as with a screw. With cutting edges 106A, 106B positioned a distance apart, a user may squeeze together handles (e.g., portions of members 102, 104) of tile nipper 100 to perform a cutting motion that forces cutting edges 106A, 106B towards one another. Additional description regarding the portions of members 102, 104 that may constitute the handles of tile nipper 100 is provided in reference to FIGS. 2A, 2B, and 3 below. In some aspects, tile nipper 100 includes an adjustment mechanism 108. In such aspects, adjustment mechanism 108 may be used to adjust a distance between cutting edges 106A, 106B without any input applied to handle portions of members 102, 104 that causes at least one of the handle portions to move relative to the other (e.g., without handles being forced together or forced apart). Stated differently, although moving one or both handles of tile nipper 100 relative to one another (e.g., forced together or forced apart) does alter a distance between the cutting edges 106A, 106B, adjustment mechanism 108 can adjust the distance without the handles being forced together or apart. In an example, adjustment mechanism 108 can configure tile nipper 100 in a first open state or a second open state. The first open state has a first maximum distance between cutting edges 106A, 106B and the second open state has a second maximum distance between cutting edges 106A, 106B that is different than the first maximum distance.

Hand size may vary among different users of tile nipper 100 and users with smaller-sized hands may find it more difficult (e.g., fatiguing) to use tile nipper 100 when cutting edges 106A, 106B are spaced apart a typical distance. The ability to adjust the distance between cutting edges 106A, 106B of tile nipper 100 absent input to the handles of the tile nipper 100 that causes at least one of the handles to move relative to the other improves the adaptability of tile nipper 100 for users with different hand sizes. Thicknesses of tiles to be cut using tile nipper 100 varies as well. Adjusting the distance between the cutting edges 106A, 106B based on tile thickness can reduce unnecessary movement of the cutting edges 106A, 106B and thereby reduce unnecessary effort by the user. In some aspects, cutting edges 106A, 106B of tile nipper 100 may be detachable, which enables the cutting edges 106A, 106B to be replaced, unlike typical tile nippers that have cutting edges welded to the main body. In some aspects, the material of which at least a portion of the body of tile nipper 100 is constructed includes aluminum, which reduces the weight of tile nipper 100 compared to typical tile nippers that have a body constructed of cast metal (e.g., iron), which improves the ease of use of tile nipper 100 without sacrificing material strength. For instance, a user may fatigue less quickly when using tile nipper 100 because of the lighter weight.

FIGS. 2A, 2B, and 3 are various view of an example implementation of tile nipper 100. Joints that facilitate rotation of two rotatably coupled components with respect to one another are described herein with reference to tile nipper 100. Any suitable joint that connects two components and enables such movement may be used. For example, a bar positioned through respective openings in each of the two components is one such suitable joint. In the illustrated implementation, member 102 includes a member 110 (e.g., third member) rotatably coupled to a member 112 (e.g., fourth member) at a joint 114A (e.g., first joint). Similarly, member 104 includes a member 116 (e.g., fifth member) rotatably coupled to a member 118 (e.g., sixth member) at a joint 114B (e.g., second joint). Member 110 is rotatably coupled to member 116 at a joint 114C (e.g., third joint). Joint 114C includes adjustment mechanism 108. Member 112 is rotatably coupled to member 118 at a joint 114D (e.g., fourth joint).

Member 110 includes a blade 301A that includes cutting edge 106A. Blade 301A is removably coupled to member 110, such as with a screw 303A, so that blade 301A can be replaced when necessary, thereby eliminating the need to obtain an entirely new tile nipper 100. Member 116 similarly includes a blade 301B that includes cutting edge 106B. Blade 301B is removably coupled to member 116, such as with a screw 303B, so that blade 301B can be replaced when necessary. In other aspects, blades 301A, 301B may be fixedly attached (e.g., welded) to members 110, 116, respectively. In various aspects, each of blades 301A, 301B may be constructed of a suitable material for cutting tile (e.g., ceramic tile), such as a material that includes carbide. In some aspects, the material of blades 301A, 301B may be coated with titanium, which can provide desirable abrasion resistance. Each of cutting edges 106A, 106B are suitably sharp to cut through tiles, such as ceramic tiles.

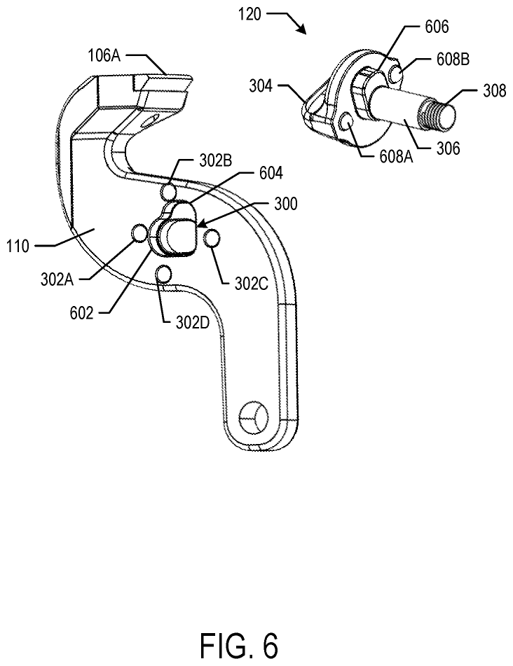

Adjustment mechanism 108 includes a component 120 (e.g., first component) and a component 122 (e.g., second component) in the illustrated implementation. First component 120 includes a knob 304. A rod 306 extends from knob 304. Rod 306 includes a threaded portion 308 at a distal end of rod 306. Second component 122 includes a threaded opening 312. Rod 306 of component 120 may be positioned through an opening 305 of member 110 and an opening 314 of member 116. Component 122 may be coupled to component 120 via the opposing threading to thereby form the joint 114C. A resilient member 310 may be positioned between member 116 and component 122 such that component 122 is biased away from member 116. As used herein, a resilient member is an elastic component that repeatedly stores and releases mechanical energy. For example, a resilient member may be any suitable spring (e.g., coil spring, extension/tension spring, machined spring, etc.). In at least some aspects, member 110 includes a recessed portion 300. The recessed portion 300 may be considered part of the adjustment mechanism 108, which will be described further in reference to FIG. 6 below. In at least some aspects, member 110 includes a plurality of indents 302A, 302B, 302C, 302D. The plurality of indents 302A, 302B, 302C, 302D may be considered part of the adjustment mechanism 108, which will be described further in reference to FIG. 6 below.

Joint 114A is formed with an opening 316A of member 110 and an opening 318B of member 112. For example, a rod may be positioned through openings 316A, 318B. Joint 114B is formed with an opening 316B of member 118 and an opening 318A of member 116. For example, a rod may be positioned through openings 316B, 318A. Joint 114D is formed with an opening 320A of member 118 and an opening 320B of member 112. For example, a rod may be positioned through openings 320A, 320B.

A portion of member 118 forms a handle 129. A grip 130 is positioned around handle 129. A portion of member 112 forms a handle 131. A grip 132 is positioned around handle 131. Grips 130, 132 may be constructed of rubber or another suitable material with sufficient grip, such as certain polymer-based materials. Grip 132 is shown having attachment structures 134A, 134B for attached a tool to tile nipper 100. For example, a hex key 136 is shown attached to grip 132. In some aspects, attachment structures 134A, 134B may be omitted. In some aspects, grips 130, 132 may be omitted. In some aspects, handles 129, 131 are constructed of the material that includes titanium while the remaining portions of members 112, 118, and members 110, 116 (minus blades 301A, 301B), are constructed of a different material, such as cast iron. In some aspects, members 112, 118 are constructed of the material that includes titanium while members 110, 116 (minus blades 301A, 301B), are constructed of a different material, such as cast iron.

Tile nipper 100 is shown including a locking mechanism that, when locked, prevents movement of handles 129, 131 relative to one another, and when unlocked, enables movement of handles 129, 131 relative to one another. The locking mechanism includes a plate 124. Plate 124 includes an opening 324 that may be used in conjunction with an opening 322A of member 118 to couple plate 124 to member 118. For example, a rod may be positioned through openings 322A, 324. In some aspects, plate 124 may be fixedly attached, or integral with, member 118. Plate 124 may also include a slot 126. The locking mechanism further includes a knob 128. Knob 128 includes a rod 326 including a distal end with threading. Rod 326 may be positioned through slot 126 and the threading of rod 326 may be coupled to member 112 via opposing threading of an opening 322B. When knob 128 is sufficiently tightened the locking mechanism is locked such that handles 129, 131 are unable to move relative to one another. When knob 128 is sufficiently loose, rod 326 can slide within slot 126 as handles 129, 131 move relative to one another. A resilient member 138 biases handles 129, 131 away from one another so that handles 129, 131 open away from one another when the locking mechanism is unlocked. Resilient member 138 may be positioned on extensions 328A, 328B. As used herein, a resilient member is an elastic component that repeatedly stores and releases mechanical energy, as described above. It will be understood that the locking mechanism can take other forms known in the art to lock and release movement of handles 129, 131 towards and away from one another. In some aspects, the locking mechanism may be omitted.

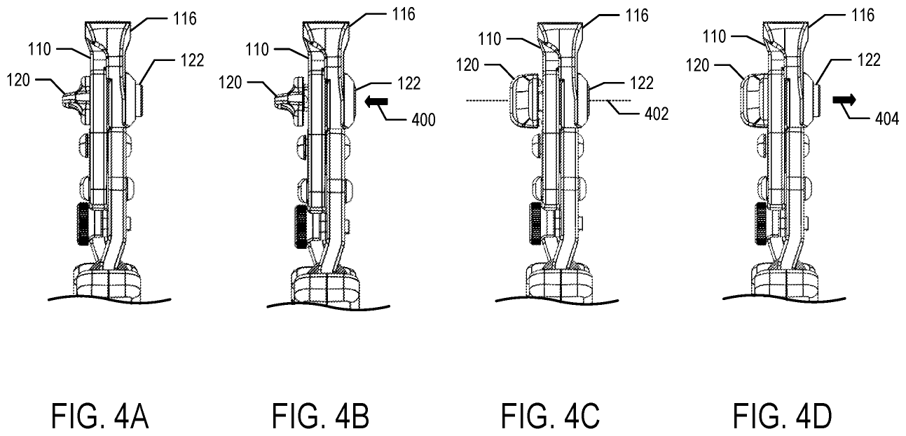

FIGS. 4A to 4D depict an operation of the adjustment mechanism 108. In FIG. 4A, components 120, 122 of adjustment mechanism 108 are shown in a set state. In FIG. 4B, component 122 as shown has been forced towards member 116 in the direction of arrow 400, which thereby has forced component 120 away from member 110 in the direction of arrow 400 as shown. The adjustment mechanism 108 is in an adjustable state in FIG. 4B. With the adjustment mechanism in an adjustable state, component 120 may be rotated about an axis 402 extending through rod 306. Rotating component 120 adjusts a distance between cutting edges 106A, 106B. The component 120 is shown rotated about 90 degrees in FIG. 4C as compared to the depiction of FIG. 4A, though component 120 may be rotated any suitable amount according to various aspects of tile nipper 100.

With component 120 rotated a desired amount to achieve a desired distance between cutting edges 106A, 106B, the force may be released from component 122 to allow adjustment mechanism 108 to return to the set state. For example, releasing the force from component 122 allows resilient member 310 to force component 122 away from member 116 in the direction of arrow 400 of FIG. 4D. Component 120 thereby moves toward member 110 in the direction of arrow 404. FIG. 4D shows components 120, 122 returned to the set state after rotation of component 120. Based on the adjustment of the adjustment mechanism 108, a distance between cutting edges 106A, 106B is adjusted.

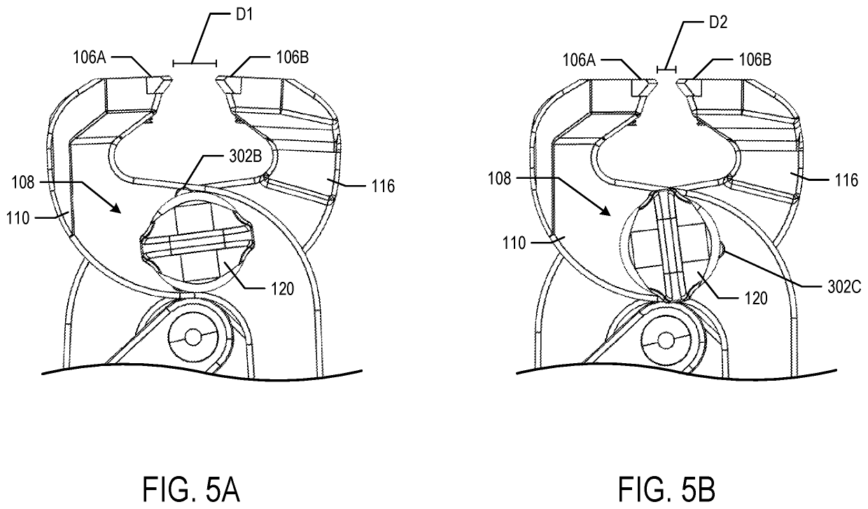

For example, FIG. 5A corresponds to FIG. 4A and depicts tile nipper 100 in a first open state with cutting edge 106A a distance D1 away from cutting edge 106A, whereas FIG. 5B corresponds to FIG. 4D and depicts tile nipper 100 in a second open state with cutting edge 106A a distance D2 away from cutting edge 106A. Distance D2 is shown in FIGS. 5A and 5B to be smaller than distance D1. It will be appreciated that in other aspects, component 120 as shown in FIG. 5A may correspond to distance D2 and component 120 as shown in FIG. 5B may correspond to distance D1. It will additionally be appreciated that, because a distance between cutting edges 106A, 106B can also be altered by input that causes at least one of handles 129, 131 to move relative to the other, the distances D1 and D2 may vary depending on positions of handles 129, 131 relative to one another, not just depending on adjustment mechanism 108. For example, the distance D2 may be larger than the distance D1 if handles 129, 131 corresponding to the depiction of FIG. 5B were allowed to fully extend away from one another while handles 129, 131 corresponding to the depiction of FIG. 5A remain the same.

A maximum possible distance between cutting edges 106A, 106B, when handles 129, 131 are fully extended away from one another, however, is necessarily greater when tile nipper 100 is set in the first open state (e.g., a first configuration) depicted in FIG. 5A than when tile nipper 100 is set in the second open state (e.g., a second configuration) depicted in FIG. 5B. The maximum possible distances are different at least because adjustment mechanism 108 is able to adjust a distance between cutting edges 106A, 106B in the absence of input that causes at least one of handles 129, 131 to move relative to the other. Stated differently, with the distance between handles 129, 131 the same in both the first open state and the second open state, distance D1 is greater than D2, and thus with the distance between handles 129, 131 spaced apart to a maximum in both the first and second open states, the distance D1 of the first open state is necessarily greater than the distance D2 of the second open state. Examples of input that causes at least one of handles 129, 131 to move relative to the other include a force bringing handles 129, 131 closer together or resilient number 138 forcing handles 129, 131 further apart.

FIG. 6 depicts perspective views of member 110 and component 120 in isolation to further describe adjustment mechanism 108. As described, member 110 includes a recessed portion 300. Recessed portion 300 is shown having a first lobe 602 and a second lobe 604 in the illustrated aspect. Component 120 is shown including a protrusion 606 extending from knob 304. Protrusion 606 can be positioned within recessed portion 300. When adjustment mechanism 108 is in a set state, protrusion 606 is positioned at least partially within lobe 602 of recessed portion 300 or at least partially within lobe 604 of recessed portion 300, but not both. For example, with the adjustment mechanism 108 in the set state depicted in FIG. 5A, protrusion 606 is positioned at least partially within lobe 604. In another example, with the adjustment mechanism 108 in the set state depicted in FIG. 5B, protrusion 606 is positioned at least partially within lobe 602. In other aspects, recessed portion 300 may have other suitable shapes. For example, recessed portion 300 may include more than two lobes so as to enable more than two positions for protrusion 606. In these aspects, protrusion 606 may have a shape that corresponds to the lobes of recessed portion 300.

As described, member 110 may include indents 302A, 302B, 302C, 302D. Component 120 is shown including secondary protrusions 608A, 608B extending from knob 304. Secondary protrusions 608A, 608B may be positioned within two indents of indents 302A, 302B, 302C, 302D, which helps maintain component 120 in positioned when adjustment mechanism 108 is in a set state. For example, secondary protrusion 608A may be positioned within indent 302C, and secondary protrusion 608B may be positioned within indent 302A, when component 120 is positioned as depicted in FIG. 5A. For instance, FIG. 5A depicts a partially visible indent 302B that is empty. In another example, secondary protrusion 608A may be positioned within indent 302B, and secondary protrusion 608B may be positioned within indent 302D, when component 120 is positioned as depicted in FIG. 5B. For instance, FIG. 5B depicts a partially visible indent 302C that is empty. In some aspects, member 110 may include less than or more than four indents. In some aspects, component 120 may include less than or more than two secondary protrusions. In some aspects, secondary protrusions 608A, 608B and indents 302A, 302B, 302C, 302D may be replaced by another suitable mechanism for helping to maintain component 120 in position, such as magnets. In some aspects, secondary protrusions 608A, 608B and indents 302A, 302B, 302C, 302D may be omitted.

In this way, adjustment mechanism 108 may include recessed portion 300 and indents 302A, 302B, 302C, 302D of member 110, components 120, 121 and resilient member 310. In some aspects, adjustment mechanism 108 includes recessed portion 300 of member 110, components 120, 121 and resilient member 310.

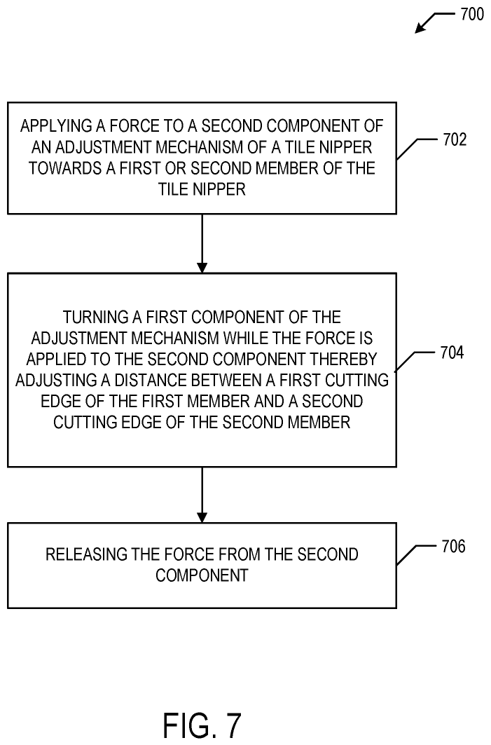

FIG. 7 is a flow chart of a method 700 of adjusting a tile nipper (e.g., tile nipper 100). In an example, method 700 may be performed by a user of tile nipper 100. At 702, a force is applied to a second component (e.g., component 122) of an adjustment mechanism (e.g., adjustment mechanism 108) of a tile nipper (e.g., tile nipper 100) towards a first or second member (e.g., member 102 or 104) of the tile nipper 100. For example, a user may press component 122 into member 104 to apply the force.

At 704, a first component (e.g., component 120) of the adjustment mechanism 108 is turned while the force is applied to the component 122 thereby adjusting a distance (e.g., distance D1 or D2) between a first cutting edge (e.g., cutting edge 106A) of the member 102 and a second cutting edge (e.g., cutting edge 106B) of the member 104. For example, while the user is pressing the component 122 into member 104 with a finger of one hand, the user may use fingers of their other hand to turn the component 120.

At 706, the force is released from the component 122. When the force is released from the component 122, the adjustment mechanism 108 returns to a set state. For example, once the user turns the component 120 a desired amount, the user can release their finger from the component 122 to allow the adjustment mechanism 108 to return to a set state.

It is noted that the order of one or more blocks (or operations) described with reference to FIG. 7 may be combined with other blocks, additional blocks may be added, and some of the block may be omitted.

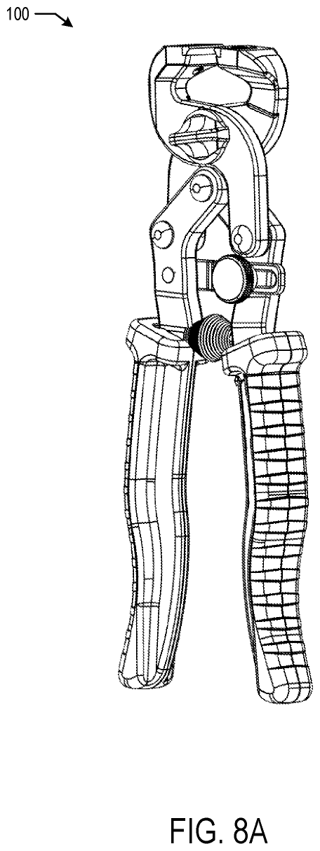

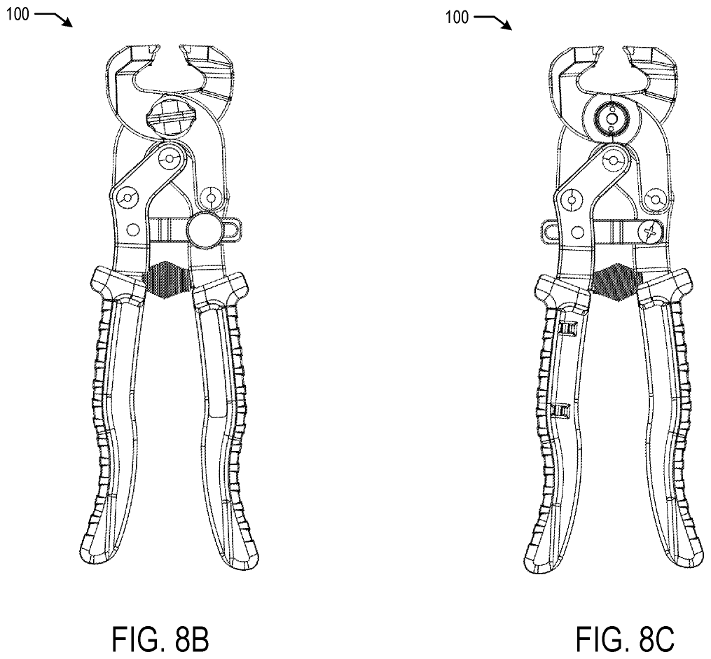

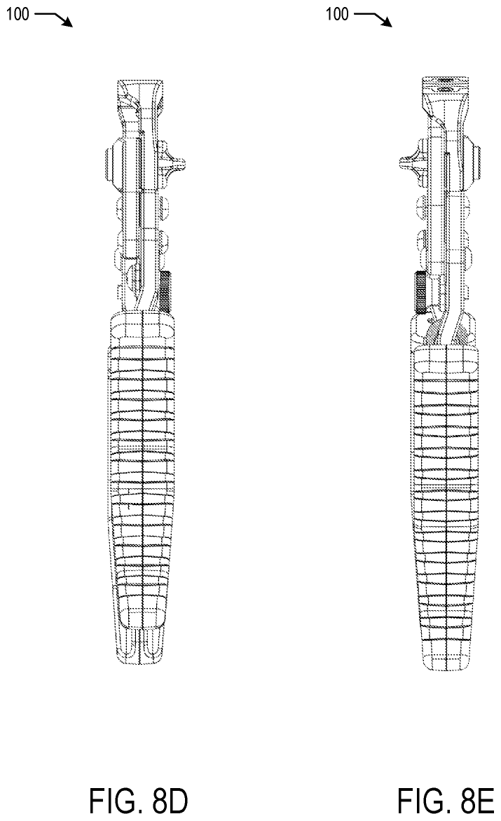

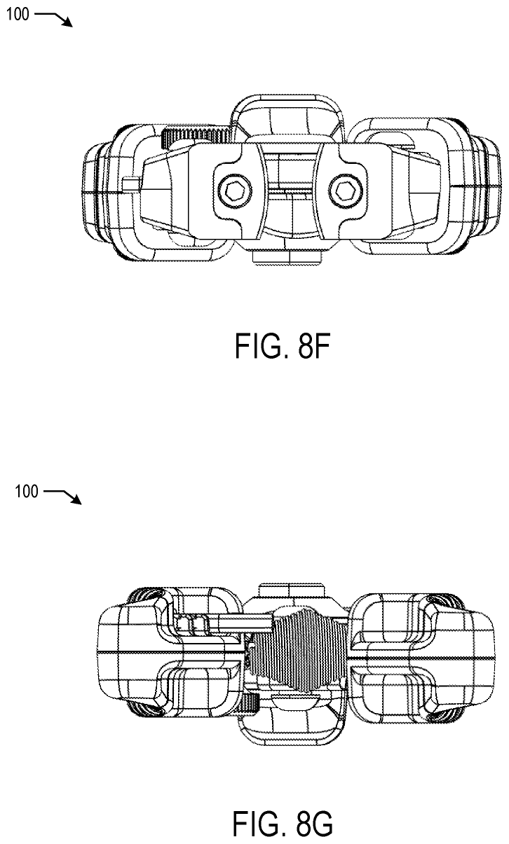

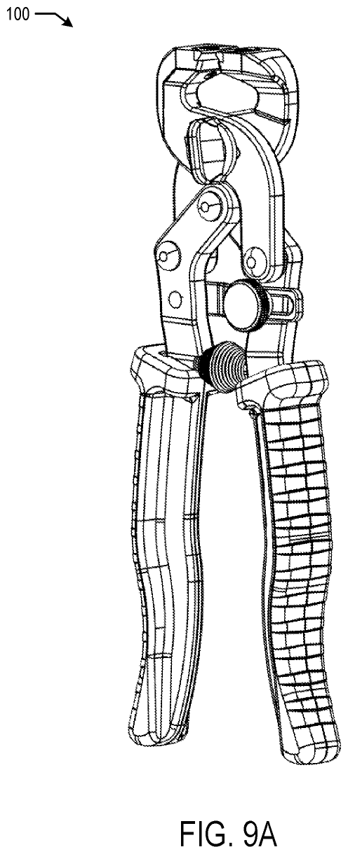

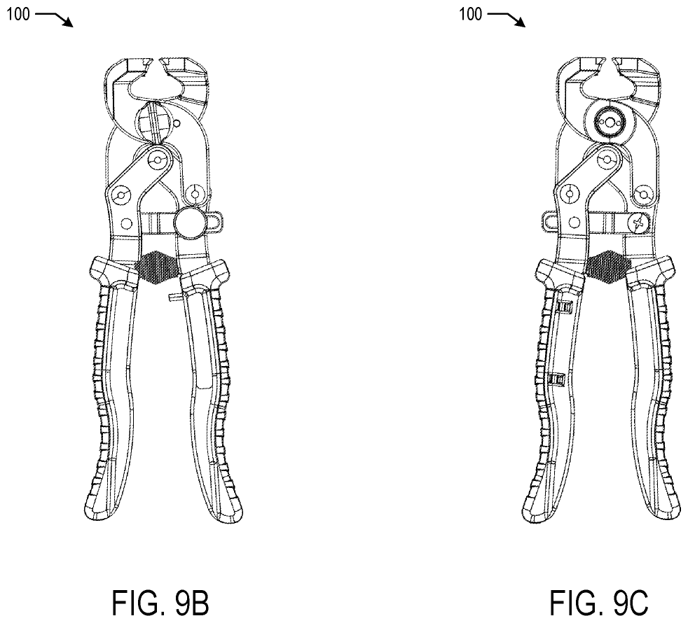

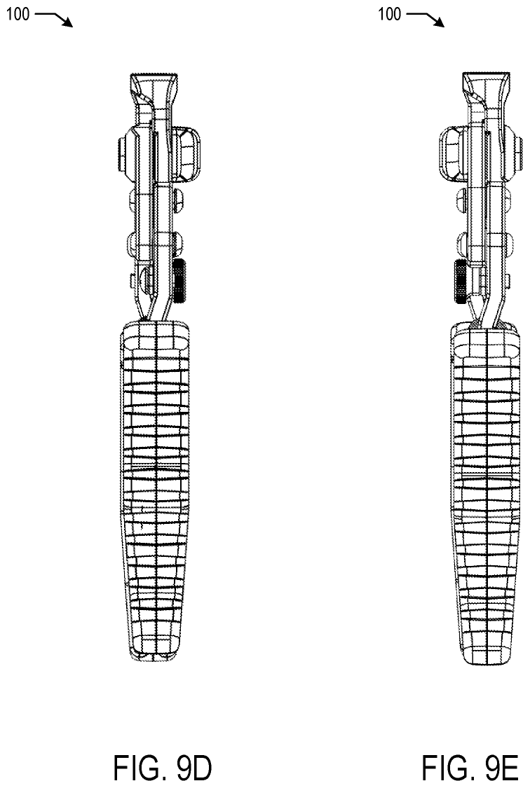

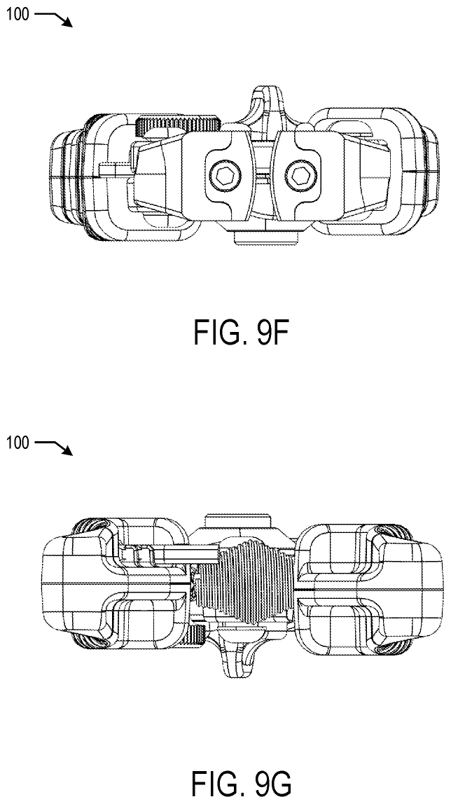

Referring to FIGS. 8A-8G and 9A-9G, diagrams of examples of a tile nipper according to one or more aspects are shown. For example, FIGS. 8A-8G include diagrams of an example (or a design) of the tile nipper 100 in a first open state (e.g., with the cutting edges 106A, 106B a first distance apart) and FIGS. 9A-9G include diagrams of an example (or a design) of the tile nipper 100 in a second open state (e.g., with the cutting edges 106A, 106B a second distance apart). In some implementations, tile nipper 100 may be associated with a different design (or representation of a design) of a tile nipper or a portion thereof.

Referring to FIGS. 8A-8G, FIG. 8A is a perspective view of tile nipper 100, FIG. 8B is a front view of tile nipper 100, FIG. 8C is a rear view of tile nipper 100, FIG. 8D is a right side view of tile nipper 100, FIG. 8E is a left side view of tile nipper 100, FIG. 8F is a top view of tile nipper 100, and FIG. 8F is a bottom view of tile nipper 100. Referring to FIGS. 9A-9G, FIG. 9A is a perspective view of tile nipper 100, FIG. 9B is a front view of tile nipper 100, FIG. 9C is a rear view of tile nipper 100, FIG. 9D is a right side view of tile nipper 100, FIG. 9E is a left side view of tile nipper 100, and FIG. 9F is a top view of tile nipper 100.

One or more solid lines of FIGS. 8A-8G and 9A-9G may be replaced with one or more broken lines. The broken lines indicate portions of tile nipper 100 that form no part of a design of tile nipper 100. Additionally, or alternatively, one or more solid lines of FIGS. 8A-8G and/or 9A-9G may be removed. For example, in some examples, one or more solid lines may be represented a broken line, one or more solid lines may be removed, or a combination thereof. In an example, each of grips 130, 132, resilient member 138, plate 124, slot 126, knob 128, the head of the screw attaching plate 124 to member 118 (e.g., see FIGS. 2B and 8C), openings 322A, 322B, joints 114A, 114B, and 114D, and components 120, 122 is depicted with broken lines in each of FIGS. 8A to 8G and 9A to 9G. In another example, each of grips 130, 132, resilient member 138, plate 124, slot 126, knob 128, the head of the screw attaching plate 124 to member 118 (e.g., see FIGS. 2B and 8C), openings 322A, 322B, and joints 114A, 114B, and 114D is depicted with broken lines in each of FIGS. 8A to 8G and 9A to 9G.

The above specification and examples provide a complete description of the structure and use of illustrative configurations. Although certain configurations have been described above with a certain degree of particularity, or with reference to one or more individual configurations, those skilled in the art could make numerous alterations to the disclosed configurations without departing from the scope of this invention. As such, the various illustrative configurations of the methods and systems are not intended to be limited to the particular forms disclosed. Rather, they include all modifications and alternatives falling within the scope of the claims, and configurations other than the one shown may include some or all of the features of the depicted configurations. For example, elements may be omitted or combined as a unitary structure, connections may be substituted, or both. Further, where appropriate, aspects of any of the examples described above may be combined with aspects of any of the other examples described to form further examples having comparable or different properties and/or functions, and addressing the same or different problems. Similarly, it will be understood that the benefits and advantages described above may relate to one configuration or may relate to several configurations. Accordingly, no single implementation described herein should be construed as limiting and implementations of the disclosure may be suitably combined without departing from the teachings of the disclosure.

As used herein, various terminology is for the purpose of describing particular implementations only and is not intended to be limiting of implementations. For example, as used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). The term “coupled” is defined as connected, although not necessarily directly, and not necessarily mechanically; two items that are “coupled” may be unitary with each other. The terms “a” and “an” are defined as one or more unless this disclosure explicitly requires otherwise. The term “substantially” is defined as largely but not necessarily wholly what is specified (and includes what is specified; e.g., substantially 90 degrees includes 90 degrees and substantially parallel includes parallel), as understood by a person of ordinary skill in the art. In any disclosed configuration, the term “substantially” may be substituted with “within [a percentage] of” what is specified, where the percentage includes. 1, 1, 5, and 10 percent.

The term “about” as used herein can allow for a degree of variability in a value or range, for example, within 10%, within 5%, or within 1% of a stated value or of a stated limit of a range and includes the exact stated value or range. The term “substantially” is defined as largely but not necessarily wholly what is specified (and includes what is specified; e.g., substantially 90 degrees includes 90 degrees and substantially parallel includes parallel), as understood by a person of ordinary skill in the art. In any disclosed implementation, the term “substantially” may be substituted with “within [a percentage] of” what is specified, where the percentage includes. 1, 1, or 5 percent; and the term “approximately” may be substituted with “within 10 percent of” what is specified. The statement “substantially X to Y” has the same meaning as “substantially X to substantially Y,” unless indicated otherwise. Likewise, the statement “substantially X, Y, or substantially Z” has the same meaning as “substantially X, substantially Y, or substantially Z,” unless indicated otherwise. The phrase “and/or” means and or. To illustrate, A, B, and/or C includes: A alone, B alone, C alone, a combination of A and B, a combination of A and C, a combination of B and C, or a combination of A, B, and C. In other words, “and/or” operates as an inclusive or. Similarly, the phrase “A, B, C, or a combination thereof” or “A, B, C, or any combination thereof” includes: A alone, B alone, C alone, a combination of A and B, a combination of A and C, a combination of B and C, or a combination of A, B, and C.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range.

The terms “comprise” (and any form of comprise, such as “comprises” and “comprising”), “have” (and any form of have, such as “has” and “having”), and “include” (and any form of include, such as “includes” and “including”) are open-ended linking verbs. As a result, an apparatus that “comprises,” “has,” or “includes” one or more elements possesses those one or more elements, but is not limited to possessing only those one or more elements. Likewise, a method that “comprises,” “has,” or “includes” one or more steps possesses those one or more steps, but is not limited to possessing only those one or more steps.

Any implementation of any of the systems, methods, and article of manufacture can consist of or consist essentially of—rather than comprise/have/include—any of the described steps, elements, and/or features. Thus, in any of the claims, the term “consisting of” or “consisting essentially of” can be substituted for any of the open-ended linking verbs recited above, in order to change the scope of a given claim from what it would otherwise be using the open-ended linking verb. Additionally, the term “wherein” may be used interchangeably with “where”.

Further, a device or system that is configured in a certain way is configured in at least that way, but it can also be configured in other ways than those specifically described. The feature or features of one implementation may be applied to other implementations, even though not described or illustrated, unless expressly prohibited by this disclosure or the nature of the implementations.

The description of the disclosed implementations is provided to enable a person skilled in the art to make or use the disclosed implementations. Various modifications to these implementations will be readily apparent to those skilled in the art, and the principles defined herein may be applied to other implementations without departing from the scope of the disclosure. Thus, the present disclosure is not intended to be limited to the implementations shown herein but is to be accorded the widest scope possible consistent with the principles and novel features as defined by the following claims. The claims are not intended to include, and should not be interpreted to include, means-plus- or step-plus-function limitations, unless such a limitation is explicitly recited in a given claim using the phrase(s) “means for” or “step for,” respectively.

1. A tile nipper comprising:
a first member comprising a first cutting edge;
a second member comprising a second cutting edge, the second member rotatably coupled to the first member; and
an adjustment mechanism configured to adjust a distance between the first cutting edge and the second cutting edge, wherein the adjustment mechanism includes:
a first component; and
a second component coupled to the first component, wherein the second component is biased away from the first or second member, and wherein operation of the first component while forcing the second component towards the first or second member adjusts the distance between the first and second cutting edges.

2. The tile nipper of claim 1, wherein the first member includes a recessed portion, the first component includes a protrusion, and the protrusion is disposed within the recessed portion.

3. The tile nipper of claim 2, wherein the recessed portion includes a first lobe and a second lobe, wherein with the protrusion disposed within the first lobe, the first cutting edge is a first distance apart from the second cutting edge, and wherein with the protrusion disposed within the second lobe, the first cutting edge is a second distance apart from the second cutting edge that is different than the first distance.

4. The tile nipper of claim 1, wherein the first member includes a plurality of indents, the first component includes a plurality of secondary protrusions, and wherein, prior to the distance between the first and second cutting edges being adjusted, the plurality of secondary protrusions are disposed within a portion of the plurality of indents.

5. The tile nipper of claim 4, wherein the plurality of indents includes a first set of indents and a second set of indents, wherein with the plurality of secondary protrusions disposed within the first set of indents, the first cutting edge is a first distance apart from the second cutting edge, and wherein with the plurality of secondary protrusions disposed within the second set of indents, the first cutting edge is a second distance apart from the second cutting edge that is different than the first distance.

6. The tile nipper of claim 1, wherein adjusting the first component includes rotating the first component about an axis.

7. The tile nipper of claim 1, wherein the first member comprises a first handle and the second member comprises a second handle, and wherein the adjustment mechanism is configured to adjust the distance between the first and second cutting edges while a distance between the first and second handles remains constant.

8. The tile nipper of claim 1, wherein the first member includes a third member rotatably coupled to a fourth member, and the second member includes a fifth member rotatably coupled to a sixth member, wherein the fourth member includes the first cutting edge and the sixth member includes the second cutting edge.

9. The tile nipper of claim 8, wherein the adjustment mechanism rotatably couples the fourth member and the sixth member.

10. The tile nipper of claim 8, wherein the third member is rotatably coupled to the fifth member.

11. The tile nipper of claim 1, wherein the first cutting edge is removably coupled to the first member and the second cutting edge is removably coupled to the second member.

12. The tile nipper of claim 1, wherein the adjustment mechanism is configured to adjust the distance between the first cutting edge and the second cutting edge between a first distance and a second distance.

13. The tile nipper of claim 12, wherein the first distance is within a range of 3 to 6 millimeters (mm), inclusive, and the second distance is within a range of 6 to 12.5 mm, inclusive.

14. A tile nipper comprising:
a first member comprising a first cutting edge; and
a second member comprising a second cutting edge, the second member rotatably coupled to the first member, wherein:
the first member comprises a third member rotatably coupled to a fourth member at a first joint, the fourth member including the first cutting edge,
the second member comprises a fifth member rotatably coupled to a sixth member at a second joint, the sixth member including the second cutting edge,
the third member is rotatably coupled to the fifth member at a third joint, and
the fourth member is rotatably coupled to the sixth member at a fourth joint.

15. The tile nipper of claim 14, further comprising:
an adjustment mechanism configured to adjust a distance between the first cutting edge and the second cutting edge, wherein the adjustment mechanism includes:
a first component; and
a second component coupled to the first component, wherein the second component is biased away from the first or second member, and wherein adjusting the first component while forcing the second component towards the first or second member adjusts the distance between the first and second cutting edges.

16. The tile nipper of claim 15, wherein the third joint includes the adjustment mechanism.

17. The tile nipper of claim 15, wherein:
the first member includes a recessed portion and the first component includes a protrusion that is disposed within the recessed portion,
the recessed portion includes a first lobe and a second lobe,
with the protrusion disposed within the first lobe, the first cutting edge is a first distance apart from the second cutting edge, and
with the protrusion disposed within the second lobe, the first cutting edge is a second distance apart from the second cutting edge that is different than the first distance.

18. The tile nipper of claim 15, wherein the first member includes a plurality of indents including a first set and a second set of indents, the first component includes a plurality of secondary protrusions, and wherein, with the plurality of secondary protrusions disposed within the first set of indents, the first cutting edge is a first distance apart from the second cutting edge, and wherein with the plurality of secondary protrusions disposed within the second set of indents, the first cutting edge is a second distance apart from the second cutting edge that is different than the first distance.

19. The tile nipper of claim 15, wherein the first and second members comprise aluminum.

20. The tile nipper of claim 14, wherein a plane extends through the first and second joints, and wherein the fourth joint is positioned between the plane and the third joint.
